(19) United States
(12) Patent Application Publication
(10) Pub. No.: US 2021/0008596 A1
(43) Pub. Date: Jan. 14, 2021

(54) SYSTEM AND METHOD FOR SIZE SEPARATING CONVEYOR

(71) Applicant: Grainflow Dynamics Inc., Livermore, CA (US)

(72) Inventor: Otis Walton, Livermore, CA (US)

(21) Appl. No.: 16/866,313

(22) Filed: May 4, 2020

Related U.S. Application Data
(60) Provisional application No. 62/828,666, filed on Apr. 3, 2019.

(51) Int. Cl. B07B 13/07; B07B 13/16

(52) U.S. Cl. CPC B07B 13/07; B07B 13/16

(57) ABSTRACT

Systems and methods for low gravity size sorting, conveying and delivery of regolith in flow rate-controlled streams that are movable and can function under terrestrial gravity conditions or at gravity levels as low as zero-G. Utilization if in-situ regolith and planetary, lunar or NEO surface ISRU operations involve selection or creation of size appropriate material for subsequent processing. Movable (articulated auger conveying lines deliver sorted feedstock to specific adjustable endpoints.

### CROSS-REFERENCE TO RELATED APPLICATION

This Non-Provisional patent application claims the benefit of the U.S. Provisional Patent Application No. 62/828,666, entitled “SYSTEM AND METHOD FOR SIZE SEPARATING CONVEYOR,” which was filed with the U.S. Patent & Trademark Office on Apr. 3, 2019, which is specifically incorporated herein by reference for all that it discloses and teaches.

### FIELD OF THE INVENTION

This invention relates generally to the field of transport, handling and sieving of materials.

### SUMMARY

An embodiment of the invention may therefore comprise a screw auger conveyor, the screw auger conveyor comprising a conveyor pipe having a first axial length section of an outer wall of the conveyor pipe comprising a first fixed grid-size screen which allows particles of a first predetermined size to pass through the screen, at least one helical conveying screw auger inside the conveyor pipe, a first vessel that collects the first predetermined size particles that pass through the first fixed grid-size screen.

An embodiment of the invention may further comprise a method of conveying and separating feedstock in a selected gravity environment, the method comprising introducing a feedstock into a cylindrical conveying pipe of a screw auger conveyor, conveying the feedstock along the screw auger conveyor via a helical conveying screw auger, collecting a first predetermined size particles in a first vessel wherein the first predetermined size particles pass through a first fixed grid size screen in an outer wall of the conveying pipe.

### BRIEF DESCRIPTION OF THE DRAWINGS

FIG. 1 shows a sequential slotted size separation system.

FIG. 2 shows a sequential slotted device for operation in a terrestrial or reduced gravity field.

FIG. 3 shows a horizontal view of size segregation system connected to a two-section articulated conveying auger having one swivel joint in the middle.

FIG. 4 shows a plan view of size segregation system connected to a two-section articulated conveying auger having one swivel joint in the middle.

FIG. 5 shows a swirl action utilized for centrifugal ejection of regolith (SAUCER) storage unit/dynamic feeder for conveying under microgravity conditions.

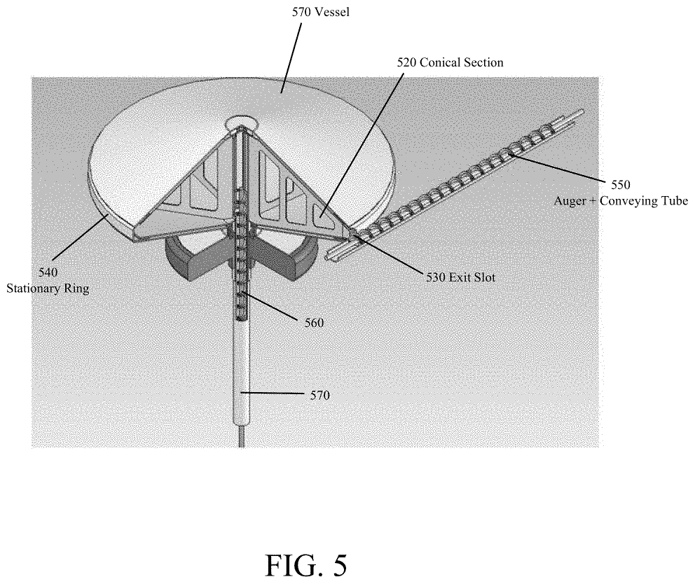

FIG. 6 shows a swirl action utilized for centrifugal ejection of regolith (SAUCER) storage unit/dynamic feeder for conveying under microgravity conditions.

FIG. 7 shows the exit of the SAUCER micro-gravity storage vessel/dynamic feeder.

FIG. 8 shows the inlet of the SAUCER micro-gravity storage vessel/dynamic feeder.

### DETAILED DESCRIPTION

The present invention describes a system and method for transporting, handling and sieving materials. The materials may be dry granular solids. The system and method of the invention both convey and size-separates the sieving materials. Unique size-separated configurations of the sieving materials are a result. Such size-separated materials may be useful in various industries, e.g. feedstock industries.

Different methods and systems can be used to move or sift materials. A screw conveyor, or rotating screw auger, may convey granular solids and may operate in one of two different modes. A screw auger may operate in a slow rotation mode, similar to an Archimedes screw with material sliding down the face of a horizontal, or slightly inclined, screw auger with minimal effects from centrifugal acceleration. A screw auger may also operate in a rapid rotation mode where the centrifugal acceleration of the material inside the conveyor exceeds the acceleration of gravity. Vertical, near vertical, or otherwise steeply inclined upward conveying screw augers generally cannot convey material if the screw rotates in a slower mode. Those skilled in the art will understand the necessary speed of rotation in consideration of an inclined upward angle in order to convey material. As such, in order to convey material up an incline, or a steep incline, a screw conveyor generally operates in a mode where the material is following a swirling vortex path of the opposite “hand” from that of the conveying screw. In other words, a left-hand vortex motion of the material in a screw conveyor with a right hand screw thread, and vice versa, generally results. As a person skilled in the art will understand, once the rotation rate of the conveying screw is at a fast enough spin rate for centrifugal acceleration at the periphery of the screw to exceed the acceleration of gravity, the mode of flow inside of the conveyor becomes a rapid swirling vortex flow mode which is also the mode of flow inside of a typical vertical screw conveyor. It has been shown experimentally that the material inside of such rapidly rotating screw conveyors (horizontal, vertical or inclined) exhibits a swirling vortex flow mode of motion similar to that utilized in vertical screw conveyors.

Sieves and sifters may also be used for separation of fine material from course material. Dry granular solids exhibit size segregation when they experience various kinds of dynamic motion in a gravity field or in an environment with a body force that resembles gravity. For example, dry granular materials exhibit size segregation, usually with the larger particles rising to the top and smaller particles migrating toward the bottom if the container holding the material is vibrated. Dry granular materials undergoing shear deformation during flow in an environment with a body force such as gravity, or centrifugal acceleration in a rotating reference frame, also exhibit size segregation somewhat similar to the segregation occurring when a bed of granular material is vibrated. Under shearing flow, smaller particles generally migrate toward the bottom, or outer region, and larger particles rise toward the top, or inner surface, of the material undergoing shear deformation in a body force environment.

Vibration or shearing flow form the physical basis for the processes that occur in most sieving, sifting, mechanical size segregation, or size classifications. Standard laboratory vibrational sieve columns consist of a vertical stack of horizontal screens attached to the bottom of pans or trays. A fixed grid size screen forms the bottom surface of each tray or pan in the vertical stack of multiple pans. The largest screen opening is on the top pan, and each successive pan below has a smaller grid size screen. When a granular material is placed in the top pan and the entire stack is strapped onto a vibration inducing drive mechanism, the granular material of various sizes slowly flows down through each of the screens for which it is small enough to pass. This results in different size fractions remaining on the different size screens in the stack. The largest particles remain in the top pan, the next size fraction is in the pan just below the top pan and so forth.

A similar screen separation or sieving method (generally termed “sifting”) depends on shearing flow instead of vibration to achieve movement of material through screens. This is generally applied to only a single screen layer since each screen requires a separate moving blade or scraper to shear the material over the screen. A means of achieving the shearing flow across a horizontally oriented screen surface is by moving a blade laterally across the screen surface, or just above the screen surface. A wire, brush or other means to mechanically move the material sitting on a horizontal screen, laterally back and forth across the screen accomplishes the same function of shearing the material sitting on the screen and induces the particles smaller than the screen openings to pass through the screen. This type of system may be referred to as a sifter.

Commercial centrifugal sifters may utilize a horizontal cylindrical screen with several very slightly tilted paddle blades rapidly rotating around a horizontal shaft. The shearing motion of the paddle blades drives particles that are small enough through the surrounding cylindrical screen and the slight tilt of the paddles slowly moves the remaining material axially along the cylinder to the axial exit for the course fraction of the material. The rapid rotating motion of the paddle blades also induces air flow radially throughout the surrounding screen which may enhance the movement of fine particles through the screen.

Embodiments of the invention may comprise a screw conveyor configuration for dry granular solids with either an open coil or a central shaft mounted helical conveying screw auger with a stationary cylindrical pipe outer wall. In some embodiments the configuration may be oriented with the conveying axis in a horizontal or upwardly sloping direction. Embodiments of the invention may further comprise a mechanism or means for feeding material into the screw augur conveyor, a mechanism or means to provide rotational torque to drive the conveying screw at rotations rates high enough that the centrifugal acceleration at the periphery of the screw is greater than the local effective gravitational acceleration, a set of one or more fixed grid size curved screens replacing selected sections of a conveying pipe wall, at different axial positions along the conveying axis to allow material of a size smaller than each screen grid to pass through that screen into separate collections vessels located at each screen section and at the end of the conveyor. With appropriate selection and positioning of the screen sections, the collection vessels separately collect material of different sizes, with the smallest size screen in the first location after the entrance and successive screens having larger grid sizes. The screens separate the material into size segregated output streams which are deposited into separate collection vessels. The size classification system of embodiments of the invention may operate independent of gravity when the rotation rate is sufficient. The size classification system of embodiments of the invention may also not depend on air flow to assist movement of finer materials through screens. Accordingly, embodiments of the invention may be suitable for use under vacuum conditions. Embodiments of the invention may operate under ambient terrestrial, lunar, or asteroid surface environments. Feeding and removing material under microgravity conditions may require special material handling equipment. Those skilled in the art will understand such special material handling equipment such as microgravity storage vessels and conveying line feeders for cohesive regolith.

Different processes and ISRU (In-Situ Resource Utilization) operations that use regolith may require feedstock material in specific size ranges and may require delivery to a movable or relocatable end-point. Some processes may need material in fixed quantity batches. Other processes may require material supplied at a steady continuous rate. Embodiments of the invention provide new and improved systems and methods to accomplish these functions independent of the prevailing gravity level. Systems and methods of the invention may also operate without any gas-solid separation steps and advances the technology readiness levels of the technologies involved.

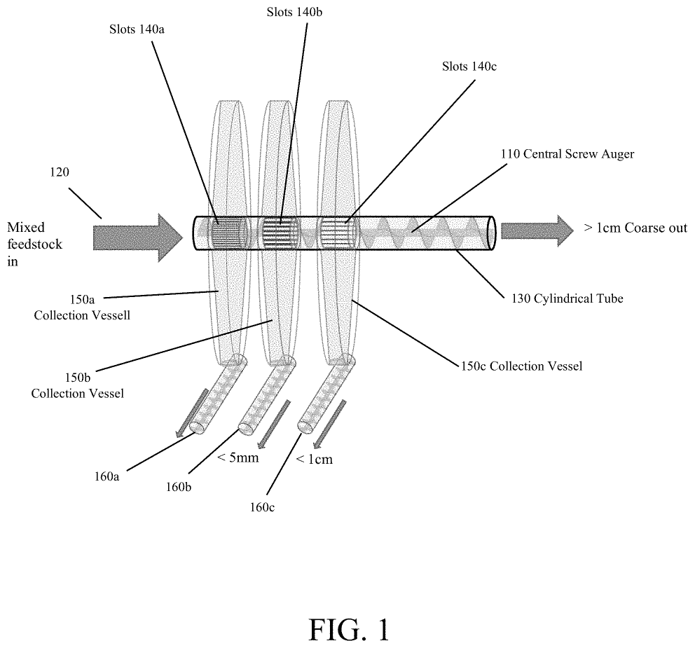

FIG. 1 shows a sequential slotted size separation system. A central screw auger 110 is used to convey regolith feedstock 120 through a cylindrical tube with successive sets of axially oriented slots 140a-c in the tube wall 130. The axially oriented slots 140a-c allow particles smaller than the slot openings to pass through the conveyor wall into a successive set of collections vessels 150a-c, or buffer volumes. The first set of slots 140a has the smallest gap size. The length of this first slotted wall 140a section is sufficient to allow all material in the original mixed size regolith feedstock 120 to pass through the slots 140a. It may be the case that the feedstock consists entirely of fine material that will fit through the smallest slots 140a. The next axial section 140b of the conveying tube 130 contains slots with a larger gap width. A larger size set of particles will pass and go into the next collection vessel 150b, or buffer volume. A third axial section 150c of the conveying tube 130 contains slots 140c with a larger gap width than both the first 140a and second 140b sets of slots. If more than three size sets are required for a particular application, then additional slotted sections can be included in the size segregating conveying tube 130. The largest particles that do not fit through any of the slotted sections 140a-c will stay inside the conveying tube 130 and are conveyed axially past the slotted wall zones 140a-c. FIG. 1 shows the larger coarse material as being of a 1 cm or larger size. This sizing is used only for example. Similarly, the sizing examples for each collection vessel 150a-c is also shown only for example. One skilled in the art will understand that any sizing variations can be used. FIG. 1 also shows a series of auger and cylindrical tube sections 160a-c for transfer of the separated feedstock 120 that has exited the central cylindrical tube 130 at the various slotted sections 140a-c.

The inclination of the segregating conveying tube 130 and some of specifics, such as the geometry of the collection vessels) are suitable to design choice based on the choices of someone skilled in the art. Different variables that may influence this may include whether the size segregation is taking place under a reduced gravity situation, similar to what one may find on earth's moon or on another planet such as Mars, or on whether the separation is being performed under very low gravity conditions as may occur on a moon of Mars or a small airless NEO (near earth object).

The pitch of the central screw auger 110 may be as small as one quarter of the diameter of the cylindrical tube 130 or as large as two diameters of the cylindrical tube. The central screw auger 110 and cylindrical tube 130 may be horizontal, or angled up at any angle, even vertical. Preferred embodiments for terrestrial-gravity implementation would generally be angled up at angles exceeding 25 degrees above horizontal. The central screw auger may be a helical open-coil screw auger that both delivers the torque and conveys material along the cylindrical tube 130. The central screw auger may have varying pitches at the different slotted sections 140a-c. Three may be different diameters of the central screw auger 110 and the surrounding conveying pipe in the successive slotted sections 140a-c. There may also be an abrupt or tapered diameter adjustment section between the different slotted sections with different diameters of the central screw auger 110 and the cylindrical tube 130.

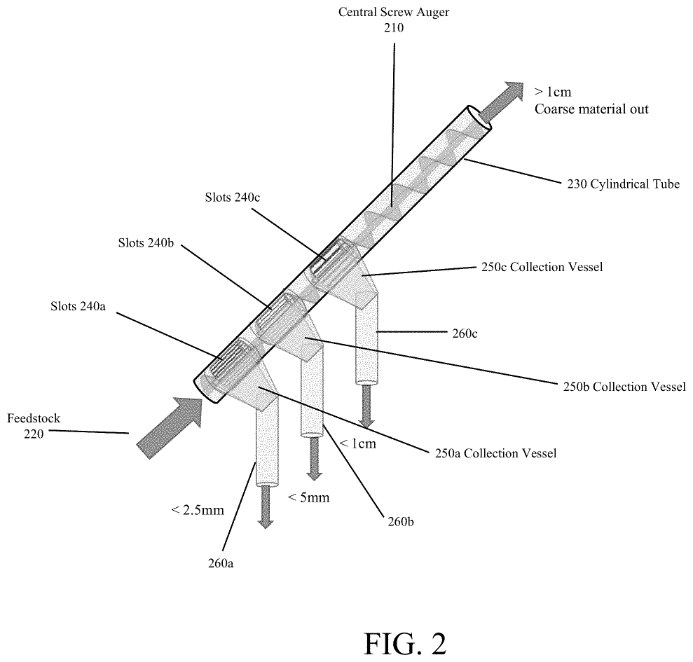

FIG. 2 shows a sequential slotted device for operation in a terrestrial or reduced gravity field. Under moderate reduced gravity, such as on Mars, the system may function most efficiently if the axis of the conveying tube is oriented in an elevated manner in relation to the direction of feedstock movement. For instance, the conveying tube may be oriented at a 45-degree angle above horizontal. FIG. 2 shows a central screw auger 210, a mixed feedstock 220 for input, a cylindrical tube 230 variable sized slot sections 240a-c, a series of collection vessels 250a-c and a series of secondary auger and tubes 160a-c similar to FIG. 1. The collection vessels 250a-c rely primarily on gravity for collection.

Vibration may also be utilized to assist for the finest feedstock size 220 which will fall through the smallest slots 240a. For near zero-gravity conditions, the unit may be at any orientation. Further the slots 240a-c can be around the entire circumference of the conveying tube 230 in near zero gravity situations. The collection vessels 140a-c as shown in FIG. 1 may each be a separately rotated centrifugal (solid pump) configuration. The separately rotated centrifugal 140a-c configuration makes the system capable of transferring material to follow on conveying lines 160a-c without relying on gravity flow.

The central conveying auger 110, 210 as shown in FIGS. 1 and 2 does not need to be efficient at conveying feedstock 220. However, the auger 110, 210 does need to shear the layer of material near the wall as it conveys. A relatively large gap between the rotating screw 110, 210 and the outer wall of the tube 130, 230 with the slots is beneficial in creating a mode of flow with significant shear near the outer wall. In vertical screw conveying, or any screw conveying under very low gravity conditions, the rotating screw induces the conveyed solids 120, 220 to move along a helical path rubbing against the outer pipe wall of the tube 130, 230. An inefficient screw conveyor with a relatively large gap between the auger and the wall will result in significant shearing within the swirling granular material, especially near the wall. When granular solids undergo shearing flow in a gravity field (or in the artificial gravity situation of a rotating reference frame) fine particles migrate to the bottom of the shearing layer. In other words, the fine particles migrate in the direction of the effective body force field, which is toward the outer pipe wall. Large particles roll up and over the smaller particles and migrate toward the top of the shearing flow, or the inner surface of the shearing granular bed. DEM (Discrete Element Method) simulations can be used to assist in selecting appropriate configuration and operating conditions that will enhance separation of cohesive fines from the mixed material feedstock entering the system.

While inefficient conveying may provide desirable characteristics for the central auger 110, 210 in the separations units shown in FIGS. 1 and 2, reasonably efficient conveyance systems and methods do have a purpose and are useful. While the use of terrestrial screw conveyors may raise concerns regarding potential jamming, as discussed above under microgravity utilization of a gap spacing between the auger screw and the conveyor wall that are larger than what might be considered acceptable by a person of ordinary skill in the art can make the conveying systems and methods both energy efficient and robust. Combining the described system and method with the use of pre-screened feedstock may make screw conveying systems a primary tool for bulk material transfer under microgravity.

Typically, in terrestrial gravity situations, in vertical or steeply inclined screw conveying, increasing the gap size improves robustness by reducing or preventing jamming. However, large gaps can decrease conveying efficiency. Accordingly, trade-offs must be made between robustness and conveying efficiency. Similarly, open-core helical screws may be more robust, but less efficient than standard central shaft augers for vertical or steeply inclined conveying. DEM simulations may be used to determine relationships between gap spacing and robustness and conveying efficiency. Such simulations may also examine conveying behavior with open coil helix screws. It may be determined how much the relations change as the gravity level is reduced in those simulations. Those skilled in the art will understand the nature and efficacy of such DEM simulations.

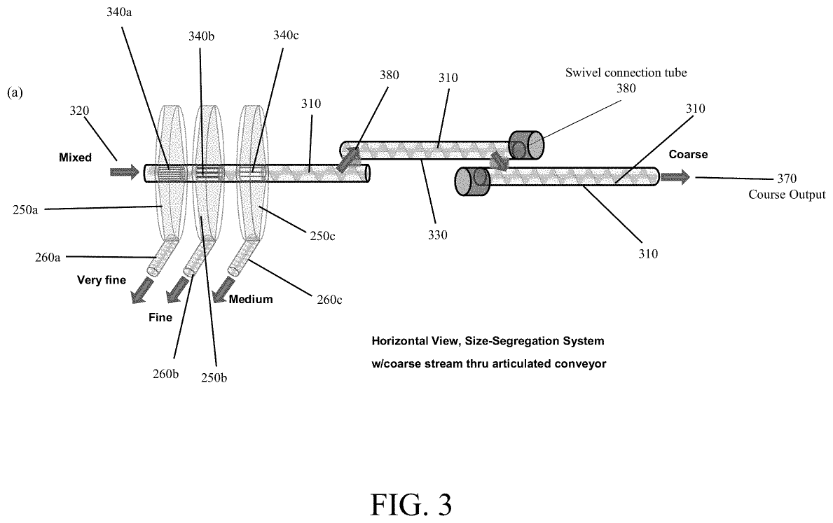

FIG. 3 shows a horizontal view of size segregation system connected to a two-section articulated conveying auger having one swivel joint in the middle. Shown is a plurality of central screw augers 310, a plurality of cylindrical tubes 330, a feedstock input 320, a series of slots 340a-c, a series of collection vessels 350a-c and a series of secondary auger and tubes 360a-c. The different screw augers 310 and cylindrical (conveying) tubes 330 are connected by swivel connections 380.

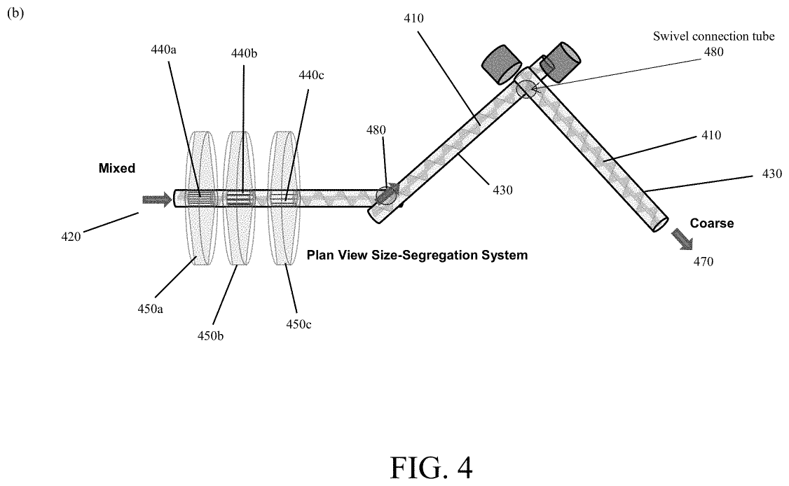

FIG. 4 shows a plan view of size segregation system connected to a two-section articulated conveying auger having one swivel joint in the middle. Shown is a plurality of central screw augers 410, a plurality of cylindrical tubes 430, a feedstock input 420, a series of slots 440a-c and a series of collection vessels 450a-c. The different screw augers 410 and cylindrical (conveying) tubes 430 are connected by swivel connections 480.

The articulated views shown in FIGS. 3 and 4 show systems an adjustable orientation, adjustable length material conveying line providing a versatile material delivery option constructed with fixed size and length parts and which may be applicable to a wide variety of different geometries or configurations. The articulated auger conveying line shown may allow delivery in any direction from the starting vessel to any location within reach of the two or three section conveying auger which has swivel joints between the sections. It is understood that there may be as many auger/conveying sections and swivel connections as are necessary. A conveying line with this type of flexibility may function as a versatile regolith feedstock conveying option allowing the delivery location to vary easily. It is understood by those skilled in the art that granular material can readily be transferred from one screw conveyor to another—either horizontally or vertically (up or down).

Fine particulates behave in a more cohesive manner than larger particles. For granular materials with a large size distribution, the bulk cohesion is most strongly influenced by the smallest size fraction in the distribution, for instance, the particles in the smallest 20% by mass. Also, as gravity level decreases, the bulk cohesive behavior of granular materials change toward the behavior normally exhibited by smaller more cohesive powders under terrestrial conditions. Measured and predicted behavior of lunar regolith simulants can provide some insight into how significant those changes in build behavior might be in going from terrestrial to lunar gravity levels.

Lunar material may not flow through centimeter scale openings under its own weight on the moon. Circular openings from conical hoppers may be sized to ensure flow, and a slot hopper may need to be also sized accordingly to ensure reliable flow under typical industrial conditions under terrestrial gravity. For instance, conical hoppers may be sized from 5 cm to 6c, in diameter and slot hoppers may be about 3 cm wide. For reliable gravity flow from a circular opening under a conical hopper, one may need to have an opening of from 30 cm to 36 cm in diameter. For a slot hopper the dimensions are somewhat smaller and only require widths of 18 cm for reliable flow under lunar gravity.

Figure S shows a swirl action utilized for centrifugal ejection of regolith (SAUCER) storage unit/dynamic feeder for conveying under microgravity conditions. The embodiment shown effectively deals with cohesive material in very low gravity environments. This centrifugal pump like storage and dispensing vessel overcomes flow problems with cohesive materials by using centrifugal acceleration to produce the motive force to move regolith out of a storage vessel and into a conveying line. There is an effective slot-hopper (based on the converging angles of the “top” to “bottom” conical section of the vessel). There is an exit slot 530 around the periphery of the SAUCER vessel 510. When the vessel 510 spins around its axis, centrifugal forces exceed the cohesive arch strength of any regolith inside and some material will be ejected through the peripheral exit slot 530 into a surrounding stationary ring 540. There may be one or more exit slots 530. An exit slot 530 may be a circular hole in the stationary ring 540 allowing the swirling material to pass through the outer ring wall and into an attaches screw conveyor 550. The material entering the conveyor 550 is then conveyed by the rotating auger/screw conveyor 550. Because the opening in the outer ring is circular, there is no preferred orientation for the attached screw conveyor 550. In some embodiments it may be preferred that the opening lie in a tangent plane to the outer circumference of the ring 540. The ring 540 and the screw conveyor 550 remain in a fixed orientation while the two conical shells of the SAUCER vessel 510 are connected together and rotate about their common axis to produce a centrifugal force enabling the material inside the SAUCER vessel 510 to be ejected through the outer slot 530 into the dispensing ring 540. An auger 560 and conveyor tube 570 is used to transfer material into the SAUCER vessel 510 along the center axis of the SAUCER vessel 510.

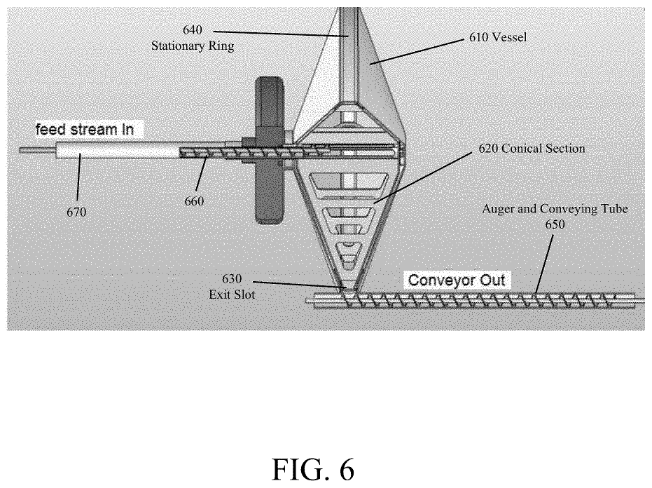

FIG. 6 shows a swirl action utilized for centrifugal ejection of regolith (SAUCER) storage unit/dynamic feeder for conveying under microgravity conditions. Shown is a SAUCER vessel 610 with an upper and lower housing, a conical section 620, an exit slot 630 in a stationary ring 640, an auger and conveying tube 650 and an input auger 660 and conveying tube 670. The operation is the same as in FIG. 6.

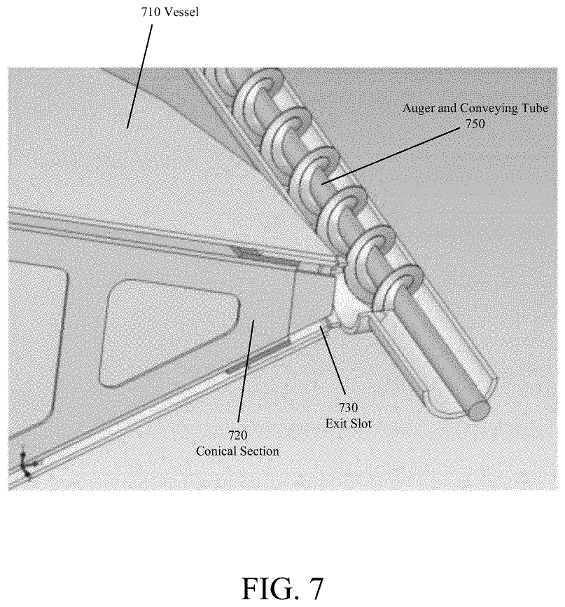

FIG. 7 shows the exit of the SAUCER micro-gravity storage vessel/dynamic feeder. Shown is the SAUCER vessel 710 with an upper and lower housing, a conical section 720, an exit slot 730 and an auger and conveying tube 750.

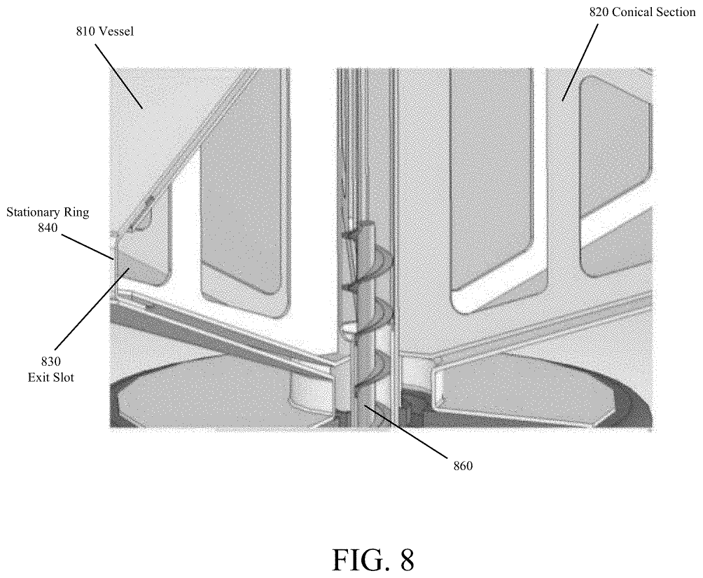

FIG. 8 shows the inlet of the SAUCER micro-gravity storage vessel/dynamic feeder. Shown is the SAUCER vessel 810 with an upper and lower housing, a conical section, an exit slot 830 in a stationary ring 840 and an input auger 860. The inlet screw/auger 860 may extend entirely through the SAUCER vessel 810 to the next stage size collection unit (not shown). The walls of the input screw auger 860 may have slots allowing the appropriate particle size material to exit through the slots into the SAUCER vessel 810.

Terrestrial mining operations invariably involve ultimate creation or selection of size appropriate feedstock for the processes that will utilize the material extracted. The final operation in most processes that involve terrestrial movement of dry granular solids is gravity flow out of one container into another vessel or processing unit. For some specialized pressurized fluid bed processes or combustion processes, more complex transfer approaches are required. Gravity flow is by far the most common method of transfer into the final process or container. Under milli-gravity or micro-gravity the small gravity driving forces that exist are very unlikely to overcome particle-particle cohesion. Accordingly, so other method and system is needed to move material into and out of containers.

What is claimed is:

1. A screw auger conveyor, said screw auger conveyor comprising:
a conveyor pipe having a first axial length section of an outer wall of said conveyor pipe comprising a first fixed grid-size screen which allows particles of a first predetermined size to pass through said screen;
at least one helical conveying screw auger inside said conveyor pipe;
a first vessel that collects said first predetermined size particles that pass through said first fixed grid-size screen.

2. The screw auger conveyor of claim 1, wherein said at least one helical conveying screw auger has a pitch between one-quarter of the conveyor pipe diameter and two conveyor pipe diameters.

3. The screw auger conveyor of claim 1, said screw auger conveyor further comprising:
a second axial length section of said outer wall of said conveyor pipe comprising a second fixed grid size screen which allows particles of a second predetermined size to pass through said second fixed grid size screen, wherein said second predetermined size is larger than said first predetermined size;
a second vessel that collects said second predetermined size particles that pass through said second fixed grid-size screen.

4. The screw auger conveyor of claim 3, said screw auger conveyor further comprising:
a third axial length section of said outer wall of said conveyor pipe comprising a third fixed grid size screen which allows particles of a third predetermined size to pass through said third fixed grid size screen, wherein said third predetermined size is larger than said second predetermined size;
a third vessel that collects said third predetermined size particles that pass through said third fixed grid-size screen.

5. The screw auger conveyor of claim 1, wherein said at least one helical conveying screw auger has a pitch between one-quarter of the conveyor pipe diameter and two conveyor pipe diameters, and wherein said screw auger conveyor further comprises:
a second axial length section of said outer wall of said conveyor pipe comprising a second fixed grid size screen which allows particles of a second predetermined size to pass through said second fixed grid size screen, wherein said second predetermined size is larger than said first predetermined size;
a second vessel that collects said second predetermined size particles that pass through said second fixed grid-size screen.

6. The screw auger conveyor of claim 1, wherein a conveying axis of said screw auger conveyor is tilted at an angle exceeding 25 degrees above horizontal.

7. The screw auger conveyor of claim 1, wherein said screw auger conveyor is situated in one of a reduced-gravity environment and a micro-gravity environment.

8. The screw auger conveyor of claim 1, wherein said helical conveying screw auger comprises a helical conveying screw auger blade.

9. The screw auger conveyor of claim 1, wherein said helical conveying screw auger comprises a helical open-coil screw auger.

10. The screw auger conveyor of claim 1, wherein said helical conveying screw auger has different pitches in different sections of said screw auger conveyor.

11. A method of conveying and separating feedstock in a selected gravity environment, said method comprising:
introducing a feedstock into a cylindrical conveying pipe of a screw auger conveyor, conveying said feedstock along said screw auger conveyor via a helical conveying screw auger;
collecting a first predetermined size particles in a first vessel wherein said first predetermined size particles pass through a first fixed grid size screen in an outer wall of said conveying pipe.

12. The method of conveying and separating feedstock of claim 11, said method further comprising collecting a second predetermined size particles in a second vessel wherein said second predetermined size particles pass through a second fixed grid size screen in said outer wall of said conveying pipe, wherein said second predetermined size particles are larger than said first predetermined size particles.

13. The method of conveying and separating feedstock of claim 12, said method further comprising collecting a third predetermined size particles in a third vessel wherein said third predetermined size particles pass through a third fixed grid size screen in said outer wall of said conveying pipe, wherein said third predetermined size particles are larger than said second predetermined size particles.

14. The method of claim 11 wherein said selected gravity environment is one of a reduced-gravity environment and a micro-gravity environment.

15. The method of claim 1 wherein said helical conveying screw auger comprises a helical conveying screw auger blade.

16. The method of claim 11 wherein said helical conveying screw auger comprises a helical open coil screw auger.

17. The method of claim 11, wherein said helical conveying screw auger has different pitches in different sections of said screw auger conveyor.
